(19) United States
(12) Patent Application Publication
(10) Pub. No.: US 2011/0185577 A1
(43) Pub. Date: Aug. 4, 2011

(54) Hand-held cutter with an auxiliary handle for performing an initial cutting operation

(76) Inventor: John S. Ronan, Temecula, CA (US)

(21) Appl. No.: 12/656,572

(22) Filed: Feb. 4, 2010

(51) Int. Cl. B23D 21/10; B26D 3/16; B26B 17/00

(52) U.S. Cl. 30/92; 30/192; 30/278; 30/330

(57) ABSTRACT

An improved hand-held cutting tool includes a first double-sided handle member having a front open cavity for receiving an anvil member. A second double-sided handle member having an upper open cavity for receiving a biased auxiliary handle therein and a front open cavity for receiving a blade holder therein. The first and second handle members are pivoted between a first open work piece placement position and a second open blade replacement position. The first open position allows a work piece to be placed on the anvil member to be cut and the second open position allows access to the blade holder for blade replacement without using tools. The auxiliary handle is biased out of the upper open cavity in the first open position to allow a user to grasp the auxiliary handle and the first handle member with one hand to easily achieve an initial cutting operation.

### CROSS REFERENCE TO RELATED APPLICATION(S)

None.

### BACKGROUND OF THE INVENTION

1. Field of the Invention

The present invention relates to the art of cutting devices and, more specifically, to hand tools and blades therefore for cutting work pieces including those having a circular cross section such as plastic pipe or tubing, rubber hose, rope, electrical cords with copper wires inside, other similar non-metallic materials or wood. More particularly, the present invention relates to a hand-held blade and anvil type cutting device or tool that has an auxiliary spring biasing handle that allows for an initial cutting or precutting operation with only one hand of user with different hand spans. Also, this invention specifically relates to a hand-held cutting device with a blade holder that is disposed between a pair of actuating handles and being movable or pivoted to a blade access open position for easily removing a razor cutting blade from the cutting device or tool without the use of any tools.

2. Description of the Related Art

Prior art conventional pipe cutters, knife/shear cutters and scissor type cutters define hand-held cutting devices or tools with a pair of handles, a fixed cutting blade with a cutting section and an anvil member. One of the handle is cooperatively connected to the cutting blade and the other handle is cooperatively connected to the anvil member. The pair of handles is affixed to one another by a pivot member and a spring element being in cooperative association therewith, wherein the handles are able to be pivoted in a scissor movement action between open and closed positions. This scissor movement allows the cutting blade to cut work pieces, material or objects that are placed on the anvil below the cutting blade, as the cutting blade is moved towards the anvil member, when a user forces or squeezes the handles together.

A wide variety of tubing cutters have been provided heretofore for cutting plastic pipe, tubing, or hose of the character used in commercial and domestic water systems, such as PVC tubing of different diameters. The scissors-type cutters which require a squeezing action of the handles require an excessive force on the part of the user to achieve a cutting operation with the use of both hands, especially with larger diameter tubing. These types of cutters or tools require a user to rock or rotate the plastic pipe, tubing or hose and the cutter in opposite directions while squeezing the handles to apply a cutting force or load thereto. Furthermore, with initially cutting through a larger diameter pipe, tubing or hose, users who have small hand spans will have difficulty in applying the necessary closing force on the handles to achieve the cutting of the pipe, tubing or hose and, often, has to grasp the handles with both hands to initiate cutting.

Another type of plastic pipe, tubing or hose cutting tool hereto available includes a cradle for supporting the plastic pipe, tubing or hose to be cut and a pivotal cutting jaw or blade which is intermittently displaced toward the cradle by means of a ratchet mechanism. This type of cutting tool is shown in U.S. Pat. No. 4,368,577 to Babb which teaches a tool having a blade member that is rotatable in increments or steps from a retracted position in which the blade is enclosed within a housing, to a cut off position in which the blade cooperates with a stationary anvil to cut or sever the plastic pipe, tubing or hose to be cut. A ratchet drive interconnects a movable handle and the blade so as to incrementally drive the blade towards its cut off position upon manipulation of the handle. A pawl mechanism prevents the opening of the blade caused by the springiness of the plastic pipe, tubing or hose being cut upon being engaged by the blade. Note that the blade is returned after cutting the plastic pipe, tubing or hose to its retracted position by releasing a thumb operated locking pawl. Also, there are other well known prior art ratchet type cutters, such as those shown in U.S. Pat. Nos. 4,176,450, 4,312,127, 4,674,184 and 6,098,291. The ratchet mechanism provided in each of the aforementioned prior art ratchet type cutters allows for a smaller stroke of the cutter handles relative to one another for each intermittent cut, whereby users without a large hand span can easily operate these cutters. In these ratchet cutters the blade maintenance including blade removal and/or replacement is very cumbersome and complex for the users. This means that these ratchet cutters must be first partially disassembled in order to remove and replace the cutter blade, which is not a quick and easy process. Typically, tools need adequate time and specialized experience in order to replace the cutting blades in the above mentioned ratchet type cutters.

It is well known in the prior art to have blade and anvil type cutters that is of the conversion type to be converted between a knife type cutter and a blade and anvil type cutter. These types of cutting devices or tools include a knife member and a companion conversion member that is cooperatively associated with or locks onto the knife member. At least a portion of the knife is sharpened to provide a secondary cutting edge, and the conversion member is cooperatively associated with or locks onto the knife member by a pivoting means to provide an anvil member that works in opposition to the secondary cutting edge for cutting work pieces, materials or objects. These blade and anvil type cutting tools or devices can be quickly and easily converted between a knife type cutting and a blade and anvil type cutting by removably attaching the conversion member.

Also, it is well known in prior art blade and anvil type cutting devices or tools to have razor blade changing mechanisms for replacing the razor blades of these cutting devices or tools with the use and without the use of blade changing tools.

There are many disadvantages in the above prior art hand-held cutting devices or tools. One of the disadvantages being that the prior art blade changing mechanisms are too cumbersome and requires too many parts or movements. A second disadvantage is that many of the prior art blade changing mechanisms have to use tools for replacing the cutting blades. These tools are very bulky and time consuming in replacing the cutting blades of the prior art hand-held cutting devices. Some of these tools have to be incorporated or attached to the prior art hand-held cutting devices or tools, which take up additional space. Another disadvantage for some of the prior art hand-held cutting devices or tools that do not utilize tools, have to be shaken vigorously so that the cutting blades are loosen in order to be removed by hand or such shaking action can cause the cutting blades to fly out, which can cause serious injury to someone.

As a result of the above disadvantages, various types of well known blade and anvil type cutting tools or devices and shear cutting tools with spring-biased handles, an anvil, a cutting blade and blade changing mechanisms that use or not use tools are found in numerous prior art patents such as U.S. Pat. Nos. 3,336,667, 3,772,783, 5,497,554, 5,625,951, 5,890,293, 6,000,137, 6,260,279, 6,269,542, 6,625,888, 6,698,099 and 7,080,455. Also, see U.S. Patent Publication Nos. 2005/00500735 and 2006/0207101.

Additional prior art patents of the hand-held blade-and-anvil type and other shear type cutting tools that teach many of the above disadvantages are also found in U.S. Design Pat. Nos. D387965, D398499, D422463, D427036, D434955, D483627 and D503875.

Although these prior art hand-held cutting devices or tools might be creative, and well-thought-out inventions, that function well for their intended purposes at the time of their creation, but they do not teach an auxiliary spring-biased handle for performing an initial cutting action to allow users with different hand spans to utilize one hand to perform an initial cut in work pieces, materials or objects. Many of these hand-held cutting devices or tools, if not all are very cumbersome and not timely in replacing cutting blades of the razor blade type from a blade holder and blade clamp assembly and they further requires unnecessary tools, screws or force to remove the cutting blades from the blade holder and blade clamp assembly.

### SUMMARY OF THE INVENTION

The present invention provides a new and improved hand-held cutting tool for shearing work pieces, such as plastic pipe or tubing, rubber hose, rope, electrical cords with copper wires inside, other similar non-metallic materials or some wood items.

The new and improved hand-held cutting tool comprises a first handle member defining a front section with a U-shaped fixed jaw portion with an anvil member attached thereto by which a work piece to be cut is at least partially received therein and supported on a portion of the anvil member. A second handle member pivotally connected via a pivot opening to the first handle member via an aligned pivot opening therein by a screw element. The second handle member having a front section with a U-shaped cavity that receives a major portion of a cutting razor blade there across. A blade holder is disposed within a portion of the second handle member and pivotally connected via a securing opening approximate a rear section thereof that is in direct alignment with the aforementioned pivot openings of the first and second handle members about the screw element there through. The blade holder has a pair of triangle shaped recesses that receives opposite corner edges of the cutting razor blade for holding the blade therein. Note that the blade holder has a complimentary U-shaped cavity disposed between a front section and an intermediate section that matches and aligns with the U-shaped cavity of the second handle member for receiving the major portion of the cutting razor blade there across. The front section of the blade holder has a small U-shaped cavity therein that supports a securing screw element that secures the front sections of the second handle member and the blade holder together. The securing screw element rests in the small U-shaped cavity when the first and second handle members are pivoted to a first open and closed position and pivoted away from the U-shaped cavity when the first and second handle members are moved to a second open razor blade access position. Also, the blade holder has a recessed portion adjacent a top rear end with a raised abutment member extending there from to the rear end thereof.

The first and second handle members are stamped out of a single piece of metal material and folded to create double-sided handles with open cavity sections there between. The first double-sided handle member having a top folded portion extending from a rear end of the first handle member to an intermediate location defining an underneath open cavity section extending from the rear end to the intermediate location. Extending from the top folded portion to a front end of the first handle member a cut-out open cavity is formed and extends from top-to bottom and being aligned in open communication with the underneath open cavity section. The second double-sided handle member has a bottom folded portion that extends upward from a rear end of the second handle member to an intermediate location thereof that defines an upper open cavity section. Extending from the bottom folded portion to a front end of the second handle member a cut-out open cavity is formed that extends from top-to-bottom and being aligned in open communication with the upper open cavity.

A first leaf spring of the first double-sided handle member is disposed in the underneath cavity with a forward end of the spring being supported on the raised abutment member of the blade holder and the rear end of the spring being secured to an interior section of the underneath cavity within the top folded portion of the first handle member at a location approximates the rear end thereof for biasing the first and second handle members toward an open position.

A second leaf spring is disposed in the upper open cavity in the bottom thereof at the bottom folded portion. The leaf spring having a rear end secured approximate the rear end of the second handle member and a forward end with a substantial U-shaped or bent portion.

In accordance with the present invention, a third handle member is disposed within the upper open cavity of the second handle member. The U-shaped or bent portion the second leaf spring abuts an under surface of the third handle member for biasing it upward to position outward of the upper cavity of the second handle member. This outward position biases a major portion of the third handle member outside of the upper cavity towards the first handle member. A forward end of the third handle member having a pivot opening that aligns with a pivot opening in an intermediate portion of the second handle member that allows a screw securing element to be received through the pivot openings of the third handle member and the second handle member for pivoting the third handle out of the upper cavity of the second handle member towards the first handle member when the first and second handle members are moved to a first open position. This pivotal movement of the third handle accommodates for an initial cutting or precutting operation with only one hand of any user with varying hand span sizes. A user is then able to grasp the first and third handle members with one hand to perform the initial cutting operation against a work piece supported on the aforementioned anvil member. Thereafter, a user can then grasp the first and second handle members with one hand, if desired, to pivot them together to finish cutting the supported work piece. Note that this third handle member eliminates the use of using the first and second handle members with two hands to perform a cutting operation of a work piece, which definitely requires more effort and force by a user.

In accordance with another aspect of the invention, the previously mentioned anvil member is preferably made of a plastic type material. The anvil member has a pair of securing holes therein, with one of the holes being off set from the center thereof but positioned in close proximity to a lower end of the anvil member. The other securing hole is disposed at an upper rear end of the anvil member. Each of the securing holes receives a screw securing element therein for securing the anvil member at the forward end of the cut-out open cavity of the first handle member. The rear end adjacent the rear securing element provides a stop surface for a lower taper surface of the blade holder when the first and second handle members are moved to the first open position. As the first and second handle members are further pivoted to the second open blade access position the lower taper surface continues to abut and ride against the stop surface, while simultaneously pivoting the blade holder angularly downward from within at least the front section of the second double-sided handle member to the razor blade access position about the screw element that pivotally secures the first and second handle members and the blade holder together. This angular and downward razor blade access position causes the blade holder to expose at least the corner of the razor blade within the triangle recess near the front section of the blade holder, as well as, an upper portion of the blade holder being angular positioned across the U-shaped cavity of the second double-sided handle member. Also, in this second open blade access position, the U-shaped cavity of the blade holder has moved to a downward and angular position that is out of alignment with the U-shaped cavity of the second double-sided handle member and the small U-shaped cavity has moved completely away from the screw element through the front sections of the second double-sided handle member and the blade holder. Such razor blade access position allows a user to easily pull the razor blade out of the triangle recesses for razor blade replacement without the use of any tools or complications.

According to another feature of the present invention, each of the first and second double-sided handle members has a handle gripping cover disposed along a portion thereon. A lower end of the gripping cover of the first double-sided handle member has an abutment or stop member at the rear end thereof to allow the rear end of the second double-sided handle member and gripping cover to abut against it when the hand-held cutting tool of the present invention is moved to a closed position.

Other features, advantages and benefits of the specific hand-held cutting tool of the present invention will become apparent to those of ordinary skill in the art upon reading and obtaining a fuller understanding of the following detailed description made in connection with the accompanying drawings.

### BRIEF DESCRIPTION OF THE DRAWINGS

A preferred embodiment of the present invention is explained in detail herein below with reference to accompanying drawings, in which:

FIG. 1 illustrates a side view of a closed position of a hand-held cutting tool with an auxiliary cutting handle and razor blade replacement mechanism in accordance with the preferred embodiment of the present invention.

FIG. 1A illustrates a side view of a first open razor blade access position of the hand-held cutting tool with an auxiliary cutting handle and razor blade replacement mechanism in accordance with the preferred embodiment of the present invention as shown in FIG. 1.

FIG. 2 illustrates a side view of a second open razor blade access position of the hand-held cutting tool with an auxiliary cutting handle and razor blade replacement mechanism in accordance with the preferred embodiment of the present invention as shown in FIG. 1.

FIG. 3 illustrates a perspective side view of the blade holder member according to the preferred embodiment of the present invention.

FIG. 4 illustrates a side view of the anvil member according to the preferred embodiment of the present invention.

FIG. 5 illustrates a side view of the first double-sided handle member according to the preferred embodiment of the present invention.

FIG. 6 illustrates a side view of the second double-sided handle member according to the preferred embodiment of the present invention.

FIG. 7 illustrates a side view of the auxiliary cutting handle according to the preferred embodiment of the present invention.

### DETAILED DESCRIPTION

Reference will now be made in detail to the preferred embodiments of the present invention, examples of which are illustrated in the accompanying drawings. While the invention will be described in conjunction with the accompanying drawings, it will be understood that they are not intended to limit the invention to the accompanying drawings. On the contrary, the present invention is intended to cover alternatives, modifications and equivalents, which may be included within the spirit and scope of the invention as defined by the appended claims.

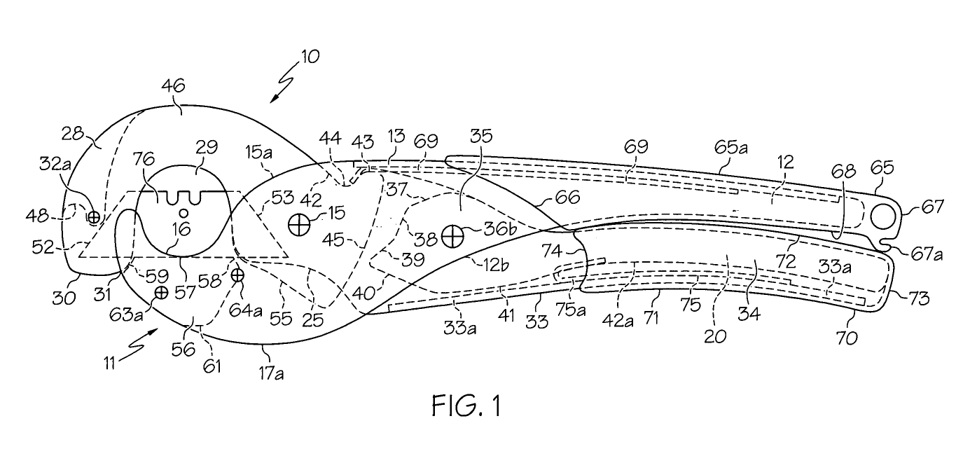

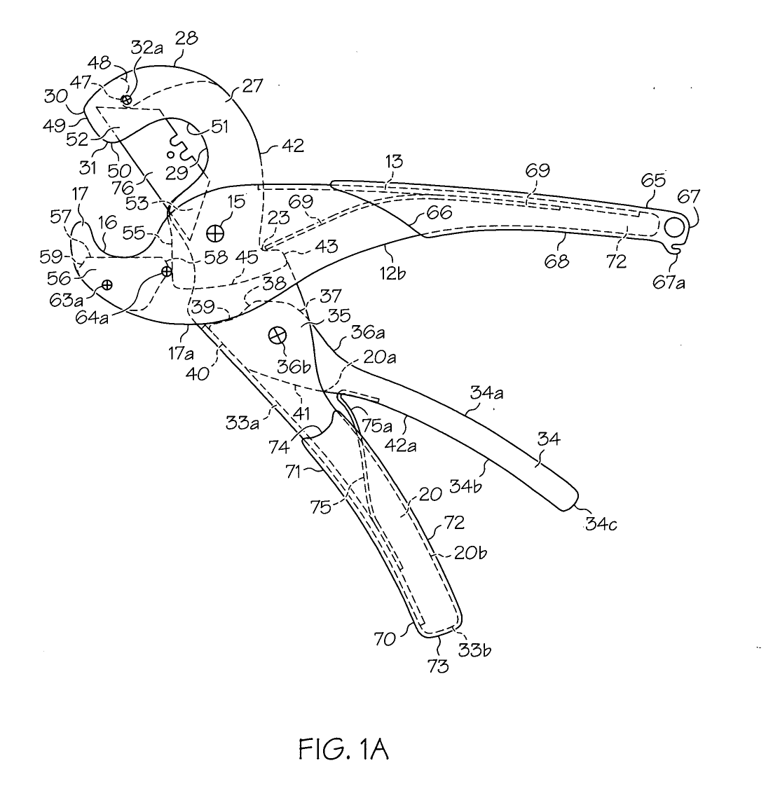

FIG. 1 illustrates the overall construction of a new and improved hand-held cutting tool of the present invention for cutting work pieces, such as plastic pipe or tubing, rubber hose, rope, electrical cords with copper wires inside, other similar non-metallic materials or some wood items. The hand held cutting tool includes a pair of operating handles 12 and 20 pivotally connected by a pivot securing or screw element 15. The handle member 12 includes a jaw and anvil device 11 and the handle member 20 includes a blade holding device 10 to be described later.

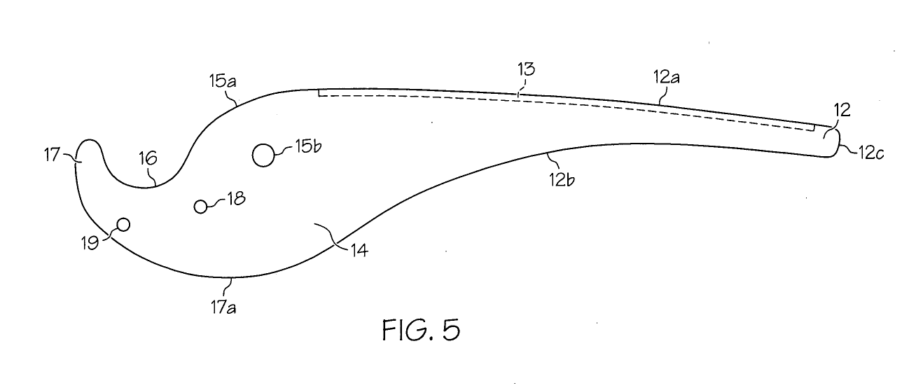

The operating handles 12 and 20 are stamped out of a single piece of metal material and folded to create double-sided handles. The first double-sided handle member 12 having a top folded portion 13 extending from a rear end of the first double-sided handle member 12 to an intermediate location 14 (as shown in FIG. 5) defining an underneath open cavity section (not shown) extending from the rear end to the intermediate location 14 of the first double-sided handle member 12. Extending from the top folded portion 13 at the intermediate location 14 to a front end 17 (as shown in FIG. 5) of the first handle member 12, a cut-out open cavity (not shown) is formed and extends from top-to bottom and being aligned in open communication with the underneath open cavity section (not shown). The front end 17 includes a top portion that descends into an arcuate jaw portion forming a U-shaped cavity 16 for supporting a work piece to be cut. The U-shaped cavity 16 continues upward into a curved shape to a top surface of the intermediate portion 14. From the intermediate portion 14, the top surface of the handle member 12 slants slightly downward along a surface 12a (shown in FIG. 5) to an arcuate or downward rear end 12c. Also, the front end 17 curves downward to a bottom surface 17a (shown in FIG. 5) to the intermediate portion 14 and continues to curve progressively upward along a surface 12b to the rear end 12c.

At the front end 17, the jaw and anvil device 11 includes an anvil member 56 (referenced by the dotted line section) that is secured within the cut-out open cavity (not shown). The anvil member 56 has a work piece top support surface 57, a first securing screw 63a, a second securing screw 64a, a top rear slant surface 58, a top front slant surface 59, a lower front slant surface 62, a lower rear slant surface 60 and a bottom surface 61. As shown in FIG. 4, the anvil member 56 has a first screw opening 63 and a second screw opening 64. As shown in FIG. 1, the first securing screw 63a is inserted through the first screw opening 63 and the second securing screw 64a is inserted through the second screw opening 64 for fixedly securing the anvil member within the cut-out cavity (not shown).

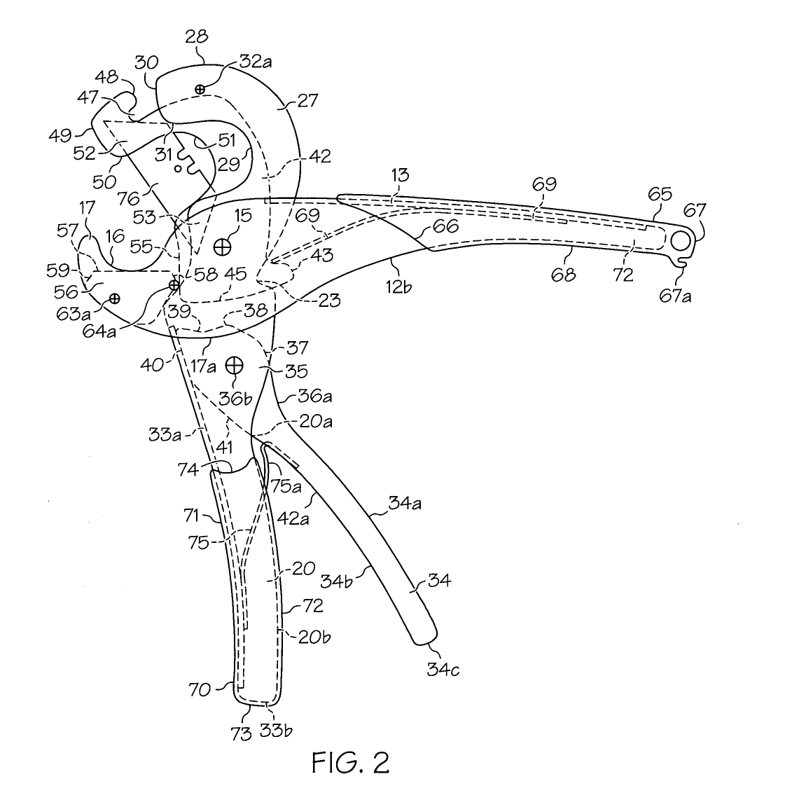

A first leaf spring 69 of the first double-sided handle member 12 is disposed in the underneath cavity with a forward end of the spring 69 being supported on a raised abutment member 43 of a blade holder 42 and the rear end of the spring 69 being secured to an interior section of the underneath cavity (not shown) within the top folded portion 13 of the first handle member 12 at a location approximates the rear end thereof for biasing the first and second handle members toward a first open work piece placement position as illustrated in FIG. 1A. This first open work piece placement position will be further described below. Also, a second open blade access position as shown in FIG. 2 will be further described below. Note that the above spring 69 assists in maintaining the blade holder in the first open work piece placement position and the second open blade access position as shown in FIG. 1A and FIG. 2, respectively. The securing of the rear end of leaf spring 69 can be achieved by various types of securing means, such as, a screw element, rivet element, or bonding means such as welding, soldering, gluing, etc., to name just a few.

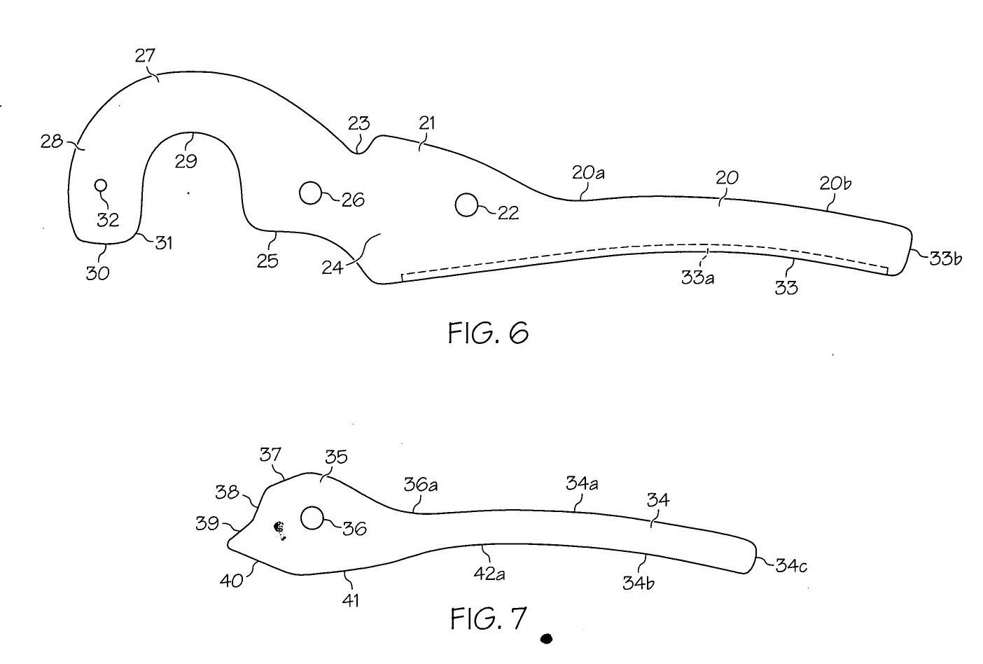

The second double-sided handle member 20 has a bottom folded portion 33a that extends upward from a rear end 33b (shown in FIG. 6) of the second handle member 20 to an intermediate location 24 thereof that defines an upper open cavity section (not shown). Extending from the bottom folded portion 33a to a front end 28 of the second handle member 20, a cut-out open cavity (not shown) is formed there between and extending from a top end to a bottom end and being in alignment and open communication with the upper open cavity (not shown). For better clarity, some of the elements of the second handle member 20 of FIG. 1 are shown in greater detail in FIG. 6. The front end 28 curves upward to a top portion 27 and continues to a downward curve section to a recess portion 23 (shown in FIG. 6). The back side of the recess portion 23 inclines upward to a top portion 21 and downward to a slight curve portion 20a and slightly upward to a curve surface 20b to a downward curved or rounded rear end portion 33b of the second double-sided handle member 20 as illustrated more clearly in FIG. 6.

The lower portion of the second double-sided handle member 20 will be now described as shown in FIG. 1. As shown in FIG. 1, the front end 28 is slightly curved downward to a bottom surface 30 with a slight upward inclined corner surface 31 (dotted line). Extending upward from the inclined corner surface 31 of the second handle member 20 is a U-shaped cavity 29 that receives a major portion of a cutting razor blade 76 there across. The U-shaped cavity 29 defines a downward slanted or curved portion 25 beginning at a location opposite to the inclined corner 31. This slanted or curved portion 25 breaks upward into a substantially slight curved bottom surface 33 of the handle member 20 and ending to the bottom of the curved or rounded rear end portion 33b.

In FIG. 1, the aforementioned bottom folded portion 33a that defines the upward extending open cavity section (not shown) within the second double-sided handle member 20, which encloses an auxiliary cutting handle member 34, 35 therein (shown in dotted lines) and is pivotally secured to the second handle member 20 by a pivoting screw member or element 36b that is through a pivoting screw opening 36 (shown in FIG. 7) of the auxiliary handle member 34, 35 and through a screw opening 22 (shown in FIG. 6) of the second double-sided handle member 20. A front portion of the auxiliary handle member 35 has a plurality of slanted surface portions that take on a head and beak-like configuration. A first slanted surface portion 37 disposed at top area of the auxiliary handle member 34, 35 with a lower end connected to a second downward slanted surface 38 extending angularly and slightly outward there from. A third slanted surface portion 39 extending angularly forward and downward from and connected to a lower end of the second slanted surface 38. A fourth slanted inward surface 40 extending angularly downward and having a first end connected to a lower end of the slanted surface 39 forming a nose shape configuration thereat. Extending from a lower end of the slanted surface 40 is a gradual upward bottom surface 41 that is adjacent or slightly spaced from an inner bottom surface of the upward extending open cavity section (not shown) at the bottom folded surface 33a of the second double-sided handle member 20 when the first and second double-sided handles 12, 20 are pivoted to a closed position about a pivoting opening 26 (as illustrated in FIG. 6). Also shown in FIG. 1, the bottom surface 41 defines an upward curve surface 42a that continues into and slightly downward surface 34b of the lower auxiliary handle 34, 35 to an upward rounded or slightly curved rear end surface 34c.

A second leaf spring 75 is disposed in the upper open cavity in the bottom (not shown) thereof at the bottom folded portion 33a. The leaf spring 75 having a rear end secured approximate the rear end of the second handle member and a forward end with a substantial U-shaped or bent portion 75a that engages the bottom surface 42a of the auxiliary handle member 34, 35 for biasing the auxiliary handle member 34, 35 out of the upper open cavity toward the first double-sided handle member 12 as shown in greater detail in FIG. 2. This position of the auxiliary handle member 12 allows users with different hand spans to grasp the auxiliary handle 34, 35 and the first double-sided handle member 12 with one hand for applying the requisite closing force on the auxiliary handle 34, 35 and the first double-sided handle member 12 to achieve an initial cutting operation of a work piece, such as plastic pipes or tubing. This eliminates a user to have to grasp the pair of double-sided handles 12, 20 with both hands to achieve an initial cutting operation of the work piece. Leaf spring 75 can be secured by various means, such as, a screw element, rivet element, or bonding means such as welding, soldering, gluing, etc., to name just a few.

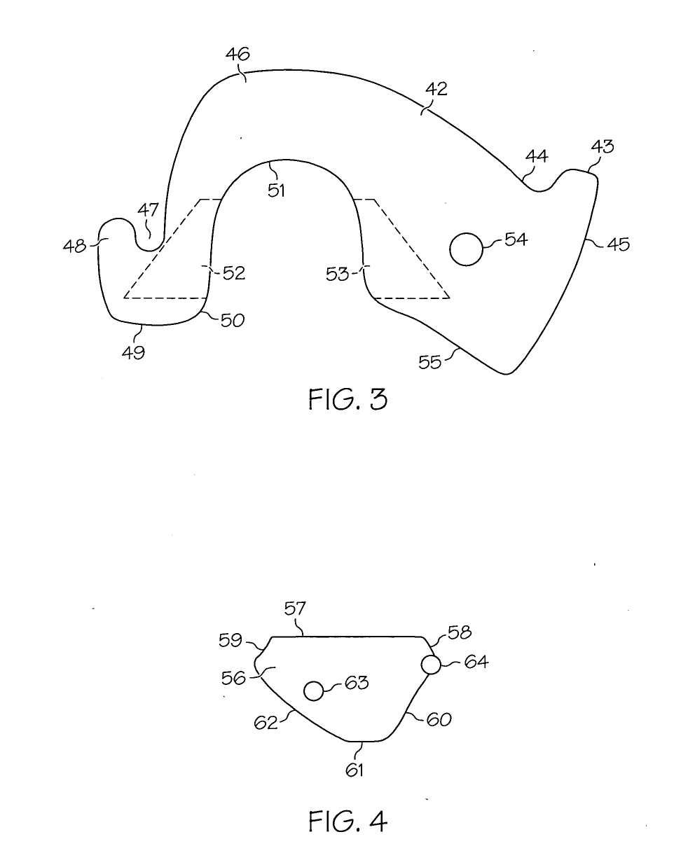

Still referring to FIG. 1, a blade holder 42 is sandwiched within the cut-out cavity (not shown) of the second double-sided handle member 20 and pivotally connected via a securing opening 54 (shown in FIG. 6) approximate a rear section thereof that is in direct alignment with pivot openings 15a, 26 of the first and second handle members about the pivot screw element 15 disposed therein. The blade holder has a pair of triangle shaped recesses 52, 53 (shown in dotted lines) that receives opposite corner edges of the cutting razor blade 76 for holding the blade therein. Note that the blade holder 42 has a complimentary U-shaped cavity 51 disposed between a front section 48 and an intermediate section 46 that matches and aligns with the U-shaped cavity 29 of the second handle member 20 for receiving the major portion of the cutting razor blade 76 there across. The front section 48 of the blade holder has a small U-shaped cavity 47 therein that supports a securing screw element 32a that secures the front sections 28, 48 of the second handle member and the blade holder together. The securing screw element 32a rests in the small U-shaped cavity 47 when the first and second handle members 12, are pivoted to a first open and closed position and pivoted away from the U-shaped cavity 47 when the first and second handle members are moved to a second open razor blade access position (as shown in FIG. 2). Also, the blade holder 42 has an upper surface having a recessed portion 44 with the raised abutment member 43 extending there from to a rear end 45. The rear end 45 curves downward from abutment 43 with a lower end being connected to one end of an upward slanted bottom surface 55. The other end of the slanted bottom surface 55 (as shown in dotted lines) is connected to one end of the U-shaped cavity 51 (as shown in FIG. 3). The other end of the U-shaped cavity 51 (as shown in dotted lines) is connected to a tapered or rounded corner 50 (as shown in FIG. 3).

Further referring to FIG. 1, the double-sided handles 12 and 20 have handle grip covering members 65 and 70, respectively. Handle grip covering 65 is disposed along a portion of handle 12. The handle grip covering 65 for handle member 12 has an upper surface 65a, a front slanted or inclined surface 66, a lower surface 68 and a rear rounded or arcuate surface 67. The lower rear end of lower surface 68 and the lower end of rear surface 67 define an abutment stop 67a for resting on the second double-sided handle member 20 when the hand-held cutting tool is in a closed position as shown in FIG. 1. The handle grip covering 70 for handle member 20 has an upper surface 72, a front arcuate or curved surface 74, a lower surface 71 and a rear rounded or arcuate surface 73.

With particular reference now to FIG. 1A, the hand-held cutting tool 10, 11 in accordance to the present invention is shown in a first open work piece placement position. This allows a work piece member, such as a plastic pipe or tubing to be placed within the U-shaped cavity of the first double-sided handle member 12 along a portion of the work piece top support surface 57 of the anvil member 56. The hand-held cutting tool 10, 11 is pivoted from the closed position of FIG. 1 to the first work piece open placement position when a user grasps the first handle member 12 and the second handle members 20 and pivots them outward away from one another. Many of the reference elements of FIG. 1A will not be described since they have been fully described in FIG. 1 above. Repeating many of these elements would be redundant and not necessary in order to understand the present invention. However, in the first work piece open placement position the blade holder 42 is fully sandwiched within the cut-out cavity (not shown) of the second double-sided handle member 20 with the screw element 32a thereof being received within the small U-shaped cavity 47 of the blade holder 42. This work piece open placement position allows a work piece to be placed in the U-shaped cavity 16 and in engagement with a portion of the top support surface 57 of the anvil member 56 for supporting a work piece to be cut. Note that when the user grasps each of the double-sided handle members 12 and 20 by moving them away from one another from the closed position of FIG. 1 to work piece open placement position of FIG. 1A. In the work piece open placement position, the complimentary U-shaped cavity 51 of the blade holder 42 remains matched and aligned with the U-shaped cavity 29 of the second handle member 20 with the major portion of the cutting razor blade 76 being disposed there across. Also, in such open placement position, the blade holder 42 remains sandwiched within the cut-out cavity (not shown) with a portion of the lower surface 55 of the blade holder resting against or near the rear surface 58 of the anvil member 56 at the location of the second securing screw element 64a of the anvil member 56. The unsecured end of spring 69 engages the raised abutment member 43 and assists in biasing and maintaining the blade holder 42 sandwiched within the cut-out cavity (not shown).

Referring now to FIG. 2, the hand-held cutting tool 10, 11 is shown in the second open blade access position. This second open blade access position is a further pivoting movement of the first handle member 12 and the second handle member 20 from the first open work piece placement position. Many of the reference elements of FIG. 2 will not be described because they have been fully described in FIG. 1 above. Repeating many of these elements would be redundant and not necessary in order to understand the present invention. In the second open blade access position the blade holder 42 is partially retracted from within the cut-out cavity (not shown) of the second double-sided handle member 20 with the small U-shaped cavity 47 of the blade holder 42 being pivoted away from the screw element 32a about the pivot screw 15 of the first and second double-sided handle members 12 and 20 when a user grasps the first handle member 12 and the second handle member 20 and pivot them further outwardly away from the first open placement position. Once the blade holder 42 is partially retracted from within the cut-out cavity (not shown), at least the triangle shaped recess 52 of the blade holder 42 is exposed so that the user can easily lift a first edge of the razor blade 76 adjacent the small U-shaped cavity 47 there from and then removing a second edge of the razor blade 76 from the other triangle recess 53 of the blade holder 42 by pulling or sliding it outwardly there from to allow for a new razor blade replacement. This pulling or sliding action is deemed necessary because the triangle recess 53 and the second edge of the razor blade 76 are still sandwiched within the cut-out cavity (not shown).

In order to insert a new replacement razor blade, first the second razor blade edge is slidably inserted into the other triangle recess 53 within the cut-out cavity (not shown) so that the first razor blade edge can be easily placed into the triangle recess 52. To tightly secure the new replacement razor blade within the triangle recesses 52 and 53, the user will grasp the first handle member 12 and the second handle member 20 and move them toward one another until the tapered or rounded corner 50 initially engages the front slant surface 59 of the anvil member 56. This initial engagement will cause the blade holder 42 to be pushed upward and completely sandwiched within the cut-out cavity (not shown) of the second handle member 20, when the blade cutting edge engages the top support surface 57 of the anvil member 56, the inclined corner 31 of the second handle member 20 engages the front slant surface 59 of the anvil member 56 and the small U-shaped cavity 47 of the blade holder 42 pivotally receives the screw 32a of the second handle member for tightly securing the improved hand-held cutting tool 10, 11 in a closed position until a user pivot the double-sided handle members 12 and 20 outwardly from one another to the aforementioned first and second open positions as discussed above.

With continued reference to FIG. 1A and FIG. 2, the second leaf spring 75 disposed in the upper open cavity in the bottom (not shown) thereof at the bottom folded portion 33a biases the auxiliary handle member 34, 35 out of the upper open cavity defined by the bottom folded portion 33a. The aforementioned substantial U-shaped or bent portion 75a of the leaf spring 75 directly engages the bottom surface 42a of the auxiliary handle member 34, 35 for biasing the auxiliary handle member 34, 35 out of the upper open cavity toward the first double-sided handle member 12 in both of the first and second open positions about pivot screw 36b. With the rear end of leaf spring 75 being secured approximate the rear end of the second handle member 20 along the interior of the bottom folded portion 33a, it causes the leaf spring 75 to bias or flex upward and outward of the above upper open cavity. As auxiliary handle member 34, 35 is biased or flexed upward the lower slanted surface 40 abuts an inner portion of the upper open cavity at the bottom folded portion 33a, the gradual bottom surface 41 moves up at angle within the upper open cavity and the bent or U-shape portion 75a acts directly along the bottom surface 42a. Note that the bottom surface 41 that continues into the upward curve surface 42a that continues into the slightly downward surface 34b of the lower auxiliary handle 34, 35 to an upward rounded or slightly curved rear end surface 34c and into the upper surface 34a that is biased completely outward of the upper open cavity by the leaf spring 75, which allows a user to have adequate handle area of the auxiliary handle 34, 35 to grasp for operation.

Note that this biasing or flexing position of the auxiliary handle member 34, 35 allows users with different hand spans to easily grasp the auxiliary handle 34, 35 and the first double-sided handle member 12 with one hand for applying the requisite closing force on the auxiliary handle 34, 35 and the first double-sided handle member 12 to achieve an initial cutting operation of a work piece, such as plastic pipes or tubing. This eliminates a user to have to grasp the pair of double-sided handles 12, 20 with both hands, which requires more force to achieve at least an initial cutting operation for different size work pieces.

With particular reference now to FIG. 3, a side view of the blade holder 42 in accordance to the present invention is shown removed from the improved hand-held cutter 10, 11. In general, the main body of the blade holder 42 includes a front end or section 48, an intermediate portion or section 46 and a rear end or section 45. The front end or section 48 defines an upper raised nose portion with one end descending to form a small U-shaped cavity 47, which continues upward in an arcuate shape to a top surface that gradually descends into a recessed portion 44 and continuing up into a raised abutment member 43. The raised abutment member 43 continues downward to the rear section end or section 45. The rear end 45 curves downward from abutment 43 with a lower end being connected to one end of the aforementioned upward slanted bottom surface 55. The other end of the slanted bottom surface 55 is connected to one end of the U-shaped cavity 51. The other end of the U-shaped cavity 51 is connected to the tapered or rounded corner 50 of the front section 48. This rounded corner 50 is further connected to a bottom surface 49, which continues upward in an arcuate or curve-like configuration to the upper raised nose portion that forms the small U-shaped cavity 47 of the front section 48. The blade holder 42 further includes a pair of cut-out triangle recesses 52 and 53. Recess 52 has an open face extending from the U-shaped cavity 51 adjacent the rounded corner 50 into the front section 48 with a bottom wall end spaced from the bottom surface 49. Note that the depth of recess 52 decreases from the bottom end to a top end that opens into the U-shaped cavity 51 by an angled back wall surface. Recess 53 has an aligned open face extending from the U-shaped cavity 51 on an opposite side thereof adjacent the end of the slanted bottom surface 55 into the blade holder 42 between the intermediate section or portion 46 and the rear end or section 45 with a bottom end spaced above the slanted bottom surface 55. Also, note that the depth of recess 53 decreases from the bottom wall end to a top end that opens into the U-shaped cavity 51 by an angled back wall surface. The varying depth is necessary for accommodating the angled edges of a razor blade, such as element 76 shown in FIGS. 1, 1A and 2. Disposed between the angled back wall surface of recess 53 and the rear end or section 45 is a screw opening for receiving the screw 15.

FIG. 4 shows a side view of the anvil member 56 being removed from the improved hand-held cutter 10, 11. The anvil member 56 includes a work piece top support surface 57 first and second ends, a first securing screw opening 63, a second securing screw opening 64, a top rear slant surface 58 with first and second ends, a top front slant surface 59 with first and second ends, a lower front slant surface 62 with first and second ends, a lower rear slant surface 60 with first and second ends and a bottom surface 61 with first and second ends. The first end of the top support surface 57 is connected to the first end of the top front slant surface 59 and the second end of the top support surface 57 is connected to the first end of the top rear slant surface 58. The second end of the top front slant surface 59 is connected to the first end of the lower front slant surface 62 and the second end of the lower front slant surface 62 is connected to the first end of the bottom surface 61. Also, the second end of the bottom surface 61 is connected to the second end of the lower rear slant surface 60 and the first end of the lower rear slant surface 60 is connected to a lower surface of the second screw opening 64. Finally, the second end of rear slant surface 58 is connected to the upper surface of the second screw opening 64. The first screw opening 63 is positioned adjacent and substantially intermediate the first and second ends of the lower front slant surface 62.

Referring now to FIG. 5, a side view of the double-sided handle member 12 of the present invention will now be described. The double-sided handle 12 is shown as being removed from the improved hand-held cutter 10, 11. Note that only one side of the handle member 12 is shown. The main body of the double-sided handle 12 includes a top folded portion 13 extending from a rear end of the first double-sided handle member 12 to a forward end that is adjacent to the intermediate location 14 defining an underneath open cavity section (not shown) extending from the rear end to the position that is adjacent to the intermediate location 14 of the first double-sided handle member 12. Extending from the forward end of the top folded portion 13 at the intermediate location 14 to a front end 17 of the first handle member 12, a cut-out open cavity (not shown) is formed and extends from top-to bottom and being aligned in open communication with the underneath open cavity section (not shown). The front end 17 includes a top nose-like portion that descends into an arcuate jaw portion forming a U-shaped cavity 16 for supporting a work piece to be cut. The U-shaped cavity 16 continues upward into a curved shape to a top surface of the intermediate portion 14. From the intermediate portion 14, the top surface of the handle member 12 slants slightly downward along a surface 12a (shown in FIG. 5) to an arcuate or downward rear end 12c. Also, the front end 17 curves downward from the nose-like portion to a bottom surface 17a (shown in FIG. 5) to the intermediate portion 14 and continues to curve progressively upward along a surface 12b to the rear end 12c.

With continued reference to FIG. 5, the double-sided handle 12 has a plurality of screw openings 15a, 18 and 19 disposed between the front end 17 and the intermediate portion 14. Screw opening 15a is positioned approximate to the top surface of the intermediate portion between the forward end of the top folded portion 13 and the upward curved shape of the U-shaped cavity 16 that connects to the top surface of the intermediate portion 14. The screw opening 18 is positioned below the upward curved shape of the U-shaped cavity 16, as well as, being spaced slightly below and from the screw opening 15a. Screw opening 19 is positioned at the front end 17 between the curve portion that is in close proximity to the nose-like portion and the bottom surface 17a. Also, the screw opening 19 is spaced from screw opening 18 and substantially in alignment therewith. The first securing screw 63a is inserted through screw opening 19 and the first screw opening 63 and the second securing screw 64a is inserted through screw opening 18 and the second screw opening 64 for fixedly securing the anvil member within the cut-out cavity (not shown) of the double-sided handle member 12. Lastly, with reference to FIG. 5, screw 15 is inserted through screw opening 15a and the screw opening 54 of the blade holder 42 and screw opening 26 of the second double-sided handle member 20 (which will be further discussed in greater detail below in FIG. 6) for securing the first handle member 12, the blade holder 42 and the second handle member 20 together.

FIG. 6 shows a side view of the second double-sided handle member 20 that is removed from the improved hand-held cutter 10, 11. The double-sided handle member 20 having a main body including a substantially slight curved bottom surface 33 of the handle member 20 with a forward end that breaks upward into a first end of a concave or curved portion 25 at an intermediate section or portion 24 and a rear end that connects to the bottom of a curved or rounded rear end portion 33b. The slightly curved bottom surface 33 further includes a bottom folded portion 33a that extends upward from a rear end 33b of the second handle member 20 and slightly downward to a forward end of the bottom folded portion 33a adjacent the intermediate location 24 that is folded upward defining an upper open cavity section (not shown) forming the double-sided handle member 20. Extending from the forward end of the bottom folded portion 33a to a front end 28 of the second handle member 20, a cut-out open cavity (not shown) is formed there between and extending from a top end to a bottom end and being in alignment and open communication with the upper open cavity (not shown). A second end of the concave or curved portion 25 breaks upward to one side of a top curve section and the other side of the curve section extending downward to a slightly inclined or rounded surface 31, forming a U-shaped cavity 29 at the front end 28. Front end 28 further includes a bottom surface 30 that is connected to the inclined or rounded corner 31 at one end with the other end curving upward to a top portion 27. Top portion 27 continues to curve downward curve to a recess portion 23. The back side of the recess portion 23 inclines upward to a top portion 21, downward to a slight curve portion 20a, and then substantially downward into a curve surface 20b to a downward curved or rounded rear end portion 33b of the second double-sided handle member 20.

Lastly, the main body of the double-sided handle member 20 has a plurality of screw openings 22, 26 and 32 therein. Note that screw opening 22 aligns with screw opening screw opening 36 of the auxiliary handle member 34, 35 with screw 36b being disposed there through for fixedly securing the auxiliary handle member 34, 35 to the second double-sided handle member 20. Screw opening 26 aligns with screw opening 54 of the blade holder 42 and screw opening 15a of the first double-sided handle member 12 with screw 15 being disposed there through for fixedly securing the first double-sided handle member 12, the second double-sided handle member 20 and the blade holder 42 together as a unit. Further, the opening 32 is disposed substantially in the middle of the front end 28 of the double-sided handle member 20 and being spaced a selective distance upward from the bottom surface 30 of the front end 28. This selective distance allows for the screw 32a that is inserted through the opening 32 to be received within the small U-shaped cavity 47 of the blade holder 42. Also, this selective distance allows the blade holder to be fully sandwiched within the cut-out cavity (not shown) of the second double-sided handle member 20 so that U-shaped cavity 29 and the bottom surface 30 of the double-sided handle member 20 aligns flush with the U-shaped cavity 51 and the bottom surface 49 of the blade holder 42. It is noted that the slightly inclined or rounded surface 31 of the double sided handle member 20 and the rounded corner 50 of the blade holder 42 will mate with the front slant surface 59 when the improved hand-held cutter 10, 11 is positioned in the closed or non-use position shown in FIG. 1.

FIG. 7 shows a side view of the auxiliary handle member 34, 35 of the present invention. The auxiliary handle member 34, 35 has a main body that includes a handle gripping portion defined by elements 34a, 34b and 34c, an intermediate portion defined by elements 36a and 42a and a head and beak-like shape or configuration portion defined by elements 35, 36, 37, 38, 39, 40 and 41. The handle gripping portion having a top surface 34a that with one end that curves slightly downward to a slightly curved or rounded rear end 34c and a forward end that continues downward to a curve or slope area at the top intermediate portion 36a. This curve or slope 36a continues upward to a head portion 35 with a first slanted or inclined surface 37. The first slanted or tapered portion 37 connects to a second downward slanted or inclined surface 38 with a third slanted or inclined surface 39 that extends outwardly at a greater angle and being connected thereto. Also, the third slanted or inclined surface 39 is connected to a fourth downward slanted or inclined surface 40 which forms a beak-like shape or configuration. Note that the fourth slanted or inclined surface 40 continues upward at a gradual angle defining a bottom surface 41 that extends between the head and beak-like shape or configuration portion 35, 36, 37, 38, 39, 40 and 41 and the intermediate portion 36a and 42a. The bottom surface 41 continues into an upward curve surface 42a and then into a slightly downward angle defining a lower hand gripping surface 34b of the lower auxiliary handle 34, 35. This lower hand gripping surface 34b extends upward and connects to the slightly rounded or curved rear end surface 34c.

With continued reference to FIG. 7, the auxiliary handle member 34, 35 has a screw opening 36 that is positioned at a selective location within the head and beak-like shape or configuration portion 35, 36, 37, 38, 39, 40, and 41 so that the screw opening 36 will align with the screw opening 22 for fixedly securing the auxiliary handle member 34, 35 to the second double-sided handle member 20. Once the auxiliary handle member 34, 35 is secured to the second double-sided handle member 20, the auxiliary handle member 34, 35 can be selectively biased in and out of the upper open cavity (not shown) by the leaf spring 75 with the bent or U-shaped portion 75a acting directly against the bottom surface 42a of the auxiliary handle member 34, 35.

It is to be appreciated that different types and shapes of screw and fastener elements could be utilized for all of the above described screw openings of the improved hand-held cutter 10, 11, if desired. Also, it is noted that the screw elements or fasteners can be inserted through the above described screw openings with the exit side of the screw openings and the screw elements or fasteners end opposite the screw elements or fasteners head portion being flush with one another. Further, if desired, either one of the above described screw elements or fasteners ends can receive a securing nut thereon. Preferably, the screw element 15 as shown in the drawings would have a securing nut disposed on its exit end opposite the head portion.

The shapes or configurations of the above described components, such as the handles, the anvil, the blade holder and the hand gripping covers can take on various other shapes and configurations to one of ordinary skill in the art, if desired. The claimed shapes and configurations of the above described components are not intended to limit the instant application. Also, the above described leaf spring can take on various other types of spring elements, such as coil springs, torsion springs, Belleville springs, and extension springs, to name just a few.

The exemplary embodiments of the present invention have been described with reference to the preferred drawing figures. Obviously, modifications and alterations will occur to others upon reading and understanding the preceding detailed description. It is intended the exemplary embodiments be construed as including all such modifications and alterations insofar as they come within the scope of the appended claims or the equivalent thereof.

What is claimed is:

1. An improved hand-held cutting tool for cutting a work piece, such as plastic pipes, tubing or hoses comprising:
a first double-sided handle member having a front end with a cut-out open portion that includes a U-shaped cavity, an intermediate securing portion and a rear handle gripping portion with a lower open cavity that is formed by an upper fold area of the first handle member, a first spring means being received within an interior of the lower open cavity along the upper fold area with a rear end secured thereto and a forward end being freely movable;
a second double-sided handle member having a front end with a cut-out open portion that includes a U-shaped cavity, the front end further includes a screw opening with a screw element disposed therein, an intermediate securing portion and a rear handle gripping portion with an upper open cavity that is formed by an lower fold area of the second handle member, the intermediate securing portions of the first and second handle members include securing openings for receiving a screw fastening means there through for pivotally connecting the first handle member to the second handle member;
an anvil member being disposed and secured within the open portion at the U-shaped cavity of the first handle member at the U-shaped by a plurality of spaced apart screw fastening elements for supporting a work piece to be cut;
a blade holder having an front end portion, a top portion, an intermediate portion and a rear end portion, the front end portion having a lower section with a small U-shaped cavity and a bottom surface with an inward edge member, the intermediate portion having a large U-shaped cavity leading from the inward edge member to a bottom incline surface, a pair of aligned razor blade edge recesses, one of the blade edge recess is disposed in the lower section and opens into the large U-shaped cavity and the other blade edge recess is disposed between the rear end portion and the intermediate portion above the bottom incline surface, a screw opening positioned outside the other blade edge recess between the intermediate portion and the rear end portion for receiving the screw fastening means of the first and second handle members for pivoting the blade holder between a closed position, a first open work piece placement position and a second open blade access replacement position, the top portion having a raised abutment adjacent the rear end portion for freely supporting the forward end of the first spring means; and
a cutting razor blade having a pair of inclined edges, one of the inclined edges is disposed in the blade edge recess that are disposed within the pair of blade edge recesses with the remaining portion of the razor blade extending across the large U-shaped cavity in all pivotal positions of the blade holder;
wherein, the replacement of the standard razor blades without tools are achieved first by a user moving the first and second handle members outwardly away from one another either from the closed position or the first open work piece placement position to the second open blade access replacement position, in the second open blade access replacement position the blade holder is partially retracted from within the cut-out open portion of the second double-sided handle member with the small U-shaped cavity of the blade holder being pivoted away from the screw element in the front end of the second handle member about the pivot screw of the first and second double-sided handle members, once the blade holder is partially retracted from within the cut-out portion of the second handle member, the blade edge recess that is disposed in the lower section and opens into the large U-shaped cavity is exposed so that the user can easily lift one of the pair of razor blade inclined edges from the lower section of the second handle member and then removing the other pair of inclined edges of the razor blade from the other blade edge recess of the blade holder by pulling and sliding it outwardly there from to allow for a new razor blade replacement therein without the use of any tools.

2. The improved hand-held cutting tool according to claim 1, wherein the first spring means is a leaf spring, the freely movable forward end of the leaf spring constantly biases against the raised abutment to assist in maintaining the blade holder in the pivoted first open placement position and the second open blade access replacement.

3. The improved hand-held cutting tool according to claim 1, wherein the anvil member includes a work piece top support surface with first and second ends, a first securing screw opening, a second securing screw opening, a top rear slant surface with first and second ends, a top front slant surface with first and second ends, a lower front slant surface with first and second ends, a lower rear slant surface with first and second ends and a bottom surface with first and second ends, the first end of the top support surface is connected to the first end of the top front slant surface and the second end of the top support surface is connected to the first end of the top rear slant surface, the second end of the top front slant surface is connected to the first end of the lower front slant surface and the second end of the lower front slant surface is connected to the first end of the bottom surface, the second end of the bottom surface is connected to the second end of the lower rear slant surface and the first end of the lower rear slant surface is connected to a lower surface of the second screw opening, the second end of rear slant surface is connected to the upper surface of the second screw opening, the first screw opening is positioned adjacent and substantially intermediate the first and second ends of the lower front slant surface.

4. The improved hand-held cutting tool according to claim 3, wherein the pair of spaced apart screw fastening elements includes first and second screw members disposed within the first and second screw openings of the anvil member for securing it within the cut-out open portion of the first handle member.

5. The improved hand-held cutting tool according to claim 1, wherein a first selective position along the bottom incline surface of the blade holder engages the anvil member at an area contiguous with the second opening and the rear slant surface when the blade holder is pivoted to the first open work piece placement position with the blade holder being fully retracted within the cut-out open portion of the second handle member for placing a work piece on the top support surface of the anvil member between the in the U-shaped cavities of the first and second handle members and the blade holder to be cut, a second selective position along the bottom incline surface of the blade holder engages the anvil member at an area contiguous with the second opening and the rear slant surface when the blade holder is pivoted to the second open blade access replacement position with a portion of the blade holder being partially retracted from the cut-out open portion of the second handle member for easy blade removal access.

6. The improved hand-held cutting tool according to claim 1, wherein an auxiliary handle is disposed within the upper open cavity that is formed by the lower fold area of the second handle member, the auxiliary handle having a plurality of slanted surfaces that forms a head and beak-like shape or configuration portion, with one of the slanted surfaces being a lower downward slanted surface, an upward angled surface extending from the downward slanted surface with an upward curve surface, a lower handle gripping portion extending from the upward curve surface to a lower end of a rear end portion, an upper handle gripping portion extending from an upper end of the rear end portion to an upward curve portion that is connected to the head portion.

7. The improved hand-held cutting tool according to claim 6, wherein the auxiliary handle is pivotally connected to the second handle member via a screw opening disposed within the upper open cavity for receiving a screw element there through, the lower downward slanted surface, the upward angled surface and the lower handle gripping portion is disposed adjacent and along an interior section of the lower fold area when the auxiliary handle is in the closed position of the improved hand-held cutting tool and being disposed within the upper open cavity, a second spring means having a rear end and a freely movable forward end, the rear end being secured to an interior surface of the lower fold area, the forward end having a shape that directly engages the lower handle gripping portion along the upward curve surface, the spring is compressed when the auxiliary spring means is in the closed position, the forward end of the spring means forces the auxiliary handle out of the upper open cavity when the first and second handle members are moved to the first open work piece placement position and the second open blade access replacement position, when the auxiliary handle is in the first open work piece placement position and a work piece is placed on the support surface of the anvil member and within the U-shaped cavity of the first handle member, a user with different hand spans will then be able to easily grasp the auxiliary handle and the first handle member with one hand for moving the U-shaped cavities of the blade holder and the second handle member over the work piece and in alignment with the U-shaped cavity of the first handle member for applying the requisite closing force on the auxiliary handle and the first double-sided handle member to achieve an initial cutting operation of a work piece, such as plastic pipes or tubing.

8. The improved hand-held cutting tool according to claim 7, wherein the head and beak-like shape or configuration, the lower slanted surface and the upward angled surface remain in the upper open cavity, the lower slanted surface engages the interior surface of the lower fold area, the second spring means forward end and the remaining portions of the auxiliary handle is biased out of the upper open cavity to allow a user to have adequate handle gripping surface to grasp.

9. The improved hand-held cutting tool according to claim 7, wherein the second spring means is a leaf spring, the forward end of the second spring means has a bent or U-shaped portion that directly engages the engages the lower handle gripping portion along the upward curve surface in all open positions of the hand-held cutting tool.

10. An improved hand-held cutting tool for cutting a work piece, such as plastic pipes, tubing or hoses comprising:
a first double-sided handle member having a front end with a cut-out open portion that includes a U-shaped cavity, an intermediate securing portion and a rear handle gripping portion with a lower open cavity that is formed by an upper fold area of the first handle member, a first spring means being received within an interior of the lower open cavity along the upper fold area with a rear end secured thereto and a forward end being freely movable;
a second double-sided handle member having a front end with a cut-out open portion that includes a U-shaped cavity, the front end further includes a screw opening with a screw element disposed therein, an intermediate securing portion and a rear handle gripping portion with an upper open cavity that is formed by an lower fold area of the second handle member, the intermediate securing portions of the first and second handle members include securing openings for receiving a screw fastening means there through for pivotally connecting the first handle member to the second handle member;
an anvil member being disposed and secured within the open portion at the U-shaped cavity of the first handle member at the U-shaped by a plurality of spaced apart screw fastening elements for supporting a work piece to be cut;
a blade holder having an front end portion, a top portion, an intermediate portion and a rear end portion, the front end portion having a lower section with a small U-shaped cavity and a bottom surface with an inward edge member, the intermediate portion having a large U-shaped cavity leading from the inward edge member to a bottom incline surface, a pair of aligned razor blade edge recesses, one of the blade edge recess is disposed in the lower section and opens into the large U-shaped cavity and the other blade edge recess is disposed between the rear end portion and the intermediate portion above the bottom incline surface, a screw opening positioned outside the other blade edge recess between the intermediate portion and the rear end portion for receiving the screw fastening means of the first and second handle members for pivoting the blade holder between a closed position, a first open work piece placement position and a second open blade access replacement position, the top portion having a raised abutment adjacent the rear end portion for freely supporting the forward end of the first spring means;
a cutting razor blade having a pair of inclined edges, one of the inclined edges is disposed in the blade edge recess that are disposed within the pair of blade edge recesses with the remaining portion of the razor blade extending across the large U-shaped cavity in all pivotal positions of the blade holder; and
an auxiliary handle is pivotally connected to the second handle member via a screw opening disposed within the upper open cavity for receiving a screw element there through, the lower downward slanted surface, the upward angled surface and the lower handle gripping portion is disposed adjacent and along an interior section of the lower fold area when the auxiliary handle is in the closed position of the improved hand-held cutting tool and being disposed within the upper open cavity, a second spring means having a rear end and a freely movable forward end, the rear end being secured to an interior surface of the lower fold area, the forward end having a shape that directly engages the lower handle gripping portion along the upward curve surface, the spring is compressed when the auxiliary spring means is in the closed position, the forward end of the spring means forces the auxiliary handle out of the upper open cavity when the first and second handle members are moved to the first open work piece placement position and the second open blade access replacement position, when the auxiliary handle is in the first open work piece placement position and a work piece is placed on the support surface of the anvil member and within the U-shaped cavity of the first handle member, a user with different hand spans will then be able to easily grasp the auxiliary handle and the first handle member with one hand for moving the U-shaped cavities of the blade holder and the second handle member over the work piece and in alignment with the U-shaped cavity of the first handle member for applying the requisite closing force on the auxiliary handle and the first double-sided handle member to achieve an initial cutting operation of a work piece, such as plastic pipes or tubing.
